(19) United States
(12) Patent Application Publication
(10) Pub. No.: US 2017/0178044 A1
(43) Pub. Date: Jun. 22, 2017

(54) DATA ANALYSIS USING TRACEABLE IDENTIFICATION DATA FOR FORECASTING TRANSPORTATION INFORMATION

(71) Applicant: SAP SE, Walldorf (DE)

(72) Inventors: Mengjiao Wang, Shanghai (CN); Wen-Syan Li, Shanghai (CN)

(21) Appl. No.: 14/976,618

(22) Filed: Dec. 21, 2015

(51) Int. Cl. G06Q 10/06

(52) U.S. Cl. CPC G06Q 10/06315

(57) ABSTRACT

A destination prediction generator accesses a passenger record database of travel records for individual passengers, and generates therefrom a classification model characterizing a probability that an individual passenger entering an origin station of a transit system will travel to a destination station of a plurality of destination stations. A passenger flow forecaster receives an ingress notification for an individual passenger at the origin station, and forecasts, based on attributes of the ingress notification as applied to the classification model, at least one predicted destination station of the plurality of destination stations. A view generator outputs, for the at least one predicted destination station, a predicted passenger flow for the at least one predicted destination that includes the individual passenger.

### TECHNICAL FIELD

This description relates to data analysis for forecasting transportation information.

### BACKGROUND

Mass transit systems, such as public transportation systems including buses and trains, play an important role in servicing the public and other (i.e., private) users. For example, such users rely on the mass transit system(s) to travel from station to station to reach a destination, such as when traveling for work, vacation, or school. Moreover, the users rely on such mass transit systems to arrive at their destinations on time and at a reasonable cost.

The providers and operators of such mass transit systems face difficulties in providing desired levels of prompt service and reasonable costs. For example, if an operator fails to have a sufficient number of trains at a train station, passengers may be left at least temporarily stranded while waiting for another train to arrive, and may arrive late at their destinations. On the other hand, if the operator has too many trains at a train station, the passengers will not require some of the trains, which will then be unused or under-used.

It is possible to track, and to some extent predict, movements of groups of users in these types of situations. For example, some systems exist that can utilize a historical database to determine that a particular train station has a large number of passengers at a certain time (e.g., during a commuting rush hour), and may then allocate more trains to that station accordingly.

### SUMMARY

In the present description, a system is described in which passenger forecasting is performed based on movements of individual passengers. Moreover, the forecasting is done based on real-time detection of a use by each passenger of traceable, identifiable travel cards, or other techniques designed to provide passenger services on an individual basis.

Accordingly, users can, for example, forecast inbound/outbound passenger flow for a particular train station, or forecast an inbound/outbound passenger flow for all stations at a particular time. Also, for each passenger, the system can estimate a destination for that passenger, e.g., as a probability distribution. In some implementations, a machine learning algorithm, such as the naïve Bayesian model, may be used to execute the destination estimation. These or similar techniques may be used, for example, using traceable smart cards, whether the smart cards are for one-time use by a random user, or are personal smart cards designed for longer-term use by an identified, individual user.

According to one general aspect, a computer program product is tangibly embodied on a non-transitory computer-readable storage medium and includes instructions that, when executed, are configured to cause at least one computing device to access a passenger record database storing passenger records corresponding to individual passengers who have travelled within a transit system, and generate a probability distribution predicting a probability of travelling to at least one destination within the transit system, after entering an origin within the transit system. The instructions, when executed, are further configured to cause the at least one computing device to receive an ingress notification of an ingress of an individual passenger at the origin within the transit system and in association with a travel of the individual passenger within the transit system, and predict the travel of the individual passenger to the at least one destination within the transit system, in response to the ingress notification and in accordance with the probability distribution.

According to another general aspect, a computer-implemented method for executing instructions stored on a non-transitory computer readable storage medium includes generating a first probability distribution predicting, for a first passenger at a first origin of a plurality of origins of a transit system, a probability of travelling therefrom to at least a first destination within the transit system, and generating a second probability distribution predicting, for a second passenger at a second origin of the plurality of origins of the transit system, a probability of travelling therefrom to at least the first destination within the transit system. The computer-implemented method further includes receiving a first ingress notification of a first individual passenger at the first origin, receiving a second ingress notification a second individual passenger at the second origin, and predicting a combined probability of travel of the first individual passenger and the second individual passenger to the first destination, based on the first probability distribution, the second probability distribution, the first ingress notification, and the second ingress notification.

According to another general aspect, a system includes instructions recorded on a non-transitory computer-readable storage medium, and executable by at least one processor. The system includes a destination prediction generator configured to access a passenger record database of travel records for individual passengers and generate therefrom a classification model characterizing a probability that an individual passenger entering an origin station of a transit system will travel to a destination station of a plurality of destination stations. The system further includes a passenger flow forecaster configured to receive an ingress notification for an individual passenger at the origin station, and further configured to forecast, based on attributes of the ingress notification as applied to the classification model, at least one predicted destination station of the plurality of destination stations. The system further includes a view generator configured to output, for the at least one predicted destination station, a predicted passenger flow for the at least one predicted destination that includes the individual passenger.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for data analysis for forecasting transportation information using individual-level traceable data.

FIG. 2 is a flowchart illustrating example implementations of the system of FIG. 1.

FIG. 3 is a flowchart illustrating more detailed example implementations of the system of FIG. 1.

FIG. 4 is a flowchart illustrating example operations of the system of FIG. 1, when using a personal smart travel card.

FIG. 5 is a screenshot of example user interfaces that may be used in the system of FIG. 1.

### DETAILED DESCRIPTION

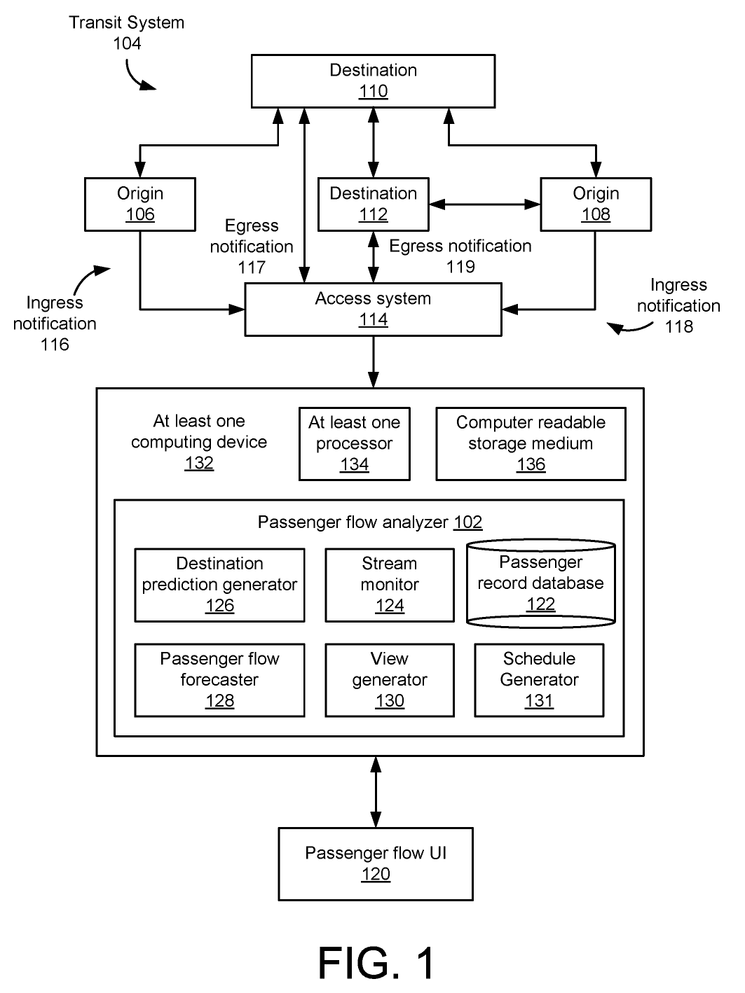

FIG. 1 is a block diagram of a system 100 for a data analysis for forecasting transportation information using individual-level traceable data. In FIG. 1, a passenger flow analyzer 102 facilitates operations of a transit system 104. In the simplified example of FIG. 1, the transit system 104 is illustrated as including a plurality of stations 106, 108, 110, and 112. More specifically, as shown, the stations 106, 108 are illustrated as origin stations, meaning that one or more passengers enter at one or both of the stations 106, 108, for the purpose of traveling to one or more of the destination stations 110, 112. Of course, as described in more detail below, it is typical for each station of the transit system 104 to serve as a potential origin station for some passengers, while serving as a destination station for other passengers.

Nonetheless, for purposes of the simplified example of FIG. 1, the stations 106, 108 are identified as origin stations, while the stations 110, 112 are illustrated as destination stations, in order to more clearly explain operations of the passenger flow analyzer 102. For example, as shown, the passenger flow analyzer 102 interacts with a access system 114, which is designed to capture ingress notifications for 116, 118 received from the origin stations 106, 108, respectively. As also illustrated in the example of FIG. 1, similar to the egress notifications 116, 118, egress notifications 117, 119 may be received by the access system 114 in response to a departure of an individual passenger from the transit system 104 at the destination stations 110, 112.

For example, in a typical scenario, a passenger may enter the transit system 104 at the origin station 106, and may swipe an access card, also referred to as a smart traffic card, in order to remit payment for desired travel within the transit system 104. In response to this access event at the origin station 106, the ingress notification 116 may be transmitted to the smart card traffic system 114. Of course, similar comments apply to an access event of a second passenger at the origin station 108, resulting in transmission of the ingress notification 118 to the access system 114. Again, similar comments would also apply to the swiping of the access card by the passenger when existing the destination stations 110, 112, resulting in egress notifications 117, 119.

Using the ingress notifications 116, 118, combined with data characterizing the transit system 104, the passenger flow analyzer 102 may be configured to forecast accurate, efficient, scalable transportation information related, for example, to scheduling arrival and departure times for transportation vehicles (e.g., trains, buses, or other vehicles), e.g., at the destination station 110. In this way, it is possible to ensure that a number and size of transportation vehicles arriving at the destination station 110 over time will correspond with a number of passengers at the destination station 110 who wish to utilize the transportation vehicles for travel thereon. In this way, transportation resources of the transit system 104 (including, e.g., the transportation vehicles, operators thereof, and associated energy resources) may be utilized in a cost efficient manner, while passengers utilizing the transit system 104 are provided with a convenient travel experience.

As shown, the passenger flow analyzer 102 may be configured to provide a passenger flow user interface (UI) 120. The passenger flow UI 120 may be utilized by an administrator or other operator of the passenger flow analyzer 102 to configure various operations of the passenger flow analyzer 102, as well as to obtain and utilize results provided by the passenger flow analyzer 102. For example, as described in detail below, the passenger flow UI 120 may be utilized to configure a manner in which the passenger flow analyzer 102 accesses and utilizes the ingress notifications 116, 118, including a manner in which the passenger flow analyzer 102 predicts travels of individual passengers within the transit system 104. The passenger flow UI 120 also may be utilized to view and utilize results of the passenger flow analyzer 102, including, e.g., viewing a map of the transit system 104, overlaid with the predicted travels of the individual passengers using the transit system 104.

In practice, the transit system 104 may represent virtually any physical travel resources associated with facilitating travel of individual passengers, along with any associated computer hardware and/or software utilized to operate such physical resources. For example, the transit system 104 may represent virtually any transportation system administered by a city or other municipal or government entity for use by residents of a corresponding city, town, or other residential area. For example, the transit system 104 may utilize trains, trams, automobiles, boats, buses, airplanes, or virtually any other transportation vehicle designed to carry one or more passengers between two or more stations of the transit system 104.

In this regard, the term station should be understood to refer to any of a number of predesignated locations within the transit system 104 at which passengers may ingress or egress to and from the transit system 104. Of course, such stations also generally represent locations at which the various transportation vehicles of the transit system 104 may schedule or unscheduled stops for the purpose of allowing the passengers to board or un-board.

The various stations 106-112 thus represent locations within the transit system 104 at which the passenger may execute an access event for accessing the transportation resources of the transit system 104, i.e., for traveling from an origin station at which the access event occurs to one or more intervening destination stations, and ultimately to a final destination station, at which the passenger egresses from the transit system 104. Generally speaking, such access events may include remittance of payment by the passenger in question, which includes utilizing an appropriate portion of a corresponding prepaid account accessible by the passenger, in response to which the passenger is granted physical access to resources of the transit system 104.

In typical examples, a passenger might arrive at the origin station 106, at which physical barriers have been provided by operators of the transit system 104 for the purpose of preventing passenger access until a corresponding access event has occurred. For example, in the context of a subway or other train station, turn styles are typically built at entrance ways to the origin station 106, so as to prevent access to trains arriving at the origin station 106.

In many of the non-limiting examples provided herein, a access system 114 is operable at the origin station 106. For example, continuing the example just given, turn styles at a subway station may be provided with card readers designed to read smart traffic cards submitted by individual passengers for the purpose of gaining access to the transit system 104. In this way, the access system 114 is operable to capture the ingress notification 116, which may include, for example, details regarding the corresponding access event by the passenger in question, including, e.g., an identity of the origin station 106, and identity of the passenger, a timestamp characterizing a time at which the access event occurred, and various other related data. As referenced above, and described in more detail below, the passenger flow analyzer 102 may thus utilize the ingress notification 116 which is captured at a level of the corresponding individual passenger, to predict passenger flow within the transit system 104 on a station-by-station basis, and thereby ensure efficient utilization of transportation resources, as well as convenient travel experiences for the various passengers.

Although many of the examples provided herein refer to the type of train-based transit system just referenced, it will be appreciated, as also referenced above, that the transit system 104 may represent many different types of public or private sector transit systems. Consequently, it will also be appreciated that the types of access events, and implementations of associated systems for tracking such access events, may vary widely. For example, the transit system 104 may utilize airplanes or helicopters, at which the various origin/destination stations would include airports, and the access system 114 may be implemented at, or in conjunction with, security checkpoints for entering the airports. In examples in which the transit system 104 includes boats or ferries, then the various origin/destination stations, and associated access systems, may be implemented at a corresponding harbor or shipyard.

Of course, in some implementations, the transit system 104 may include multiple ones of such types of transportation vehicles, operated in conjunction with one another in order to provide a cohesive transit system. For example, a city or other municipal body may operate a plurality of buses and subway trains in conjunction with one another, in order to provide public transportation to as many locations as financially and physically feasible within the city in question. Similarly, any two or more of the above-referenced types of transit systems may be combined as needed/feasible for the purpose of providing a desired level of transportation service.

In some implementations, the transit system 104 may include automobiles, vans, or buses traveling on public or private roadways, and the various origin/destination stations may represent or include toll booths or other access points for entering such roadways of the transit system 104. Additionally, or alternatively, if such vehicles (e.g., taxis, or buses) admit passengers at publically accessible locations, such as an airport or roadside, then the corresponding station of the transit system 104 may be understood to represent the publically accessible location, while the access system 114 may be implemented at the vehicle itself. That is, for example, the corresponding access event at the taxi or bus would include remitting payment, or a promise of payment, when gaining access to the vehicle itself.

In operation, the access system 114 may be implemented as a distributed system, in which access events at a plurality of origin stations are captured and corresponding data is transmitted to one or more central locations. In examples referenced herein, access events may be conducted for the access system 114 using a smart traffic card or other access card. Of course, many other types of access systems may be used. For example, passengers may utilize their smartphones, tablets, or other electronic devices to communicate with components of the access system 114 at an individual origin station, such as when a passenger utilizes a smartphone with near field communication (NFC) capabilities, or other smartphone-based payment systems. In other example implementations, the access system 114 may utilize radio frequency identification (RFID), barcode technology, or other known or future access tokens or other access technologies.

In some implementations, the access system 114 may be implemented and controlled entirely by the entity operating the transit system 104, or agent thereof. For example, when the transit system 104 is implemented by a city or other municipal body, the access system 114 may be implemented by the same agency charged with implementing the transit system 104 itself. Similarly, if the transit system 104 represents a transit system implemented by a company or other private enterprise, then the same company or enterprise, or agents thereof, may be tasked with implementing, maintaining and operating the access system 114.

On the other hand, the access system 114, or portions thereof, may be implemented and operated by a third-party provider. For example, in example scenarios in which the transit system 104 represents a metropolitan subway system, the subway authorities may implement physical aspects of the access system 114 (e.g., subway turn styles), while a third-party provider is tasked with capturing the individual ingress notifications 116, 118, and subsequent processing, storage, and reporting thereof.

Similarly, the passenger flow analyzer 102 may be implemented by the same entity operating the transit system 104 and/or the access system 114. In other implementations, however, the passenger flow analyzer 102 may be provided as a third-party service to the entity operating the transit system 104. Of course, where some or all of the access system 114 is provided by a third-party provider, the passenger flow analyzer 102 may be provided by the same or different third-party provider.

Through use of the access system 114, a passenger record database 122 may be maintained. For example, as just referenced, the passenger record database 122 may be maintained by the access system 114, and accessed by the passenger flow analyzer 102, or, the passenger flow analyzer 102 may access data captured by the access system 114, and may create and maintain the passenger record database 122. For example, the access system 114 may maintain an access database (not shown in FIG. 1) storing all information captured by the various ingress notifications 116, 118, while the passenger flow analyzer 102 may filter such access data in order to create and maintain the passenger record database 122 as including only that passenger record data determined to be useful in operations of the passenger flow analyzer 102. In other words, for example, the passenger flow UI 120 may be utilized to configure a manner in which the passenger flow analyzer 102 interfaces with the access system 114 to obtain passenger record data, and may be utilized to configure the manner in which the passenger flow analyzer 102 maintains and accesses the passenger record database 122. In some implementations, the passenger record database 122 may be implemented as an in-memory database, such as the HANA in-memory database of SAP SE of Walldorf Germany.

Thus, for example, the passenger flow analyzer 102 may include a stream monitor 124 that is configured to interface with the access system 114 and populate the passenger record database 122. For example, as just referenced, the stream monitor 124 may be configured to filter passenger record data obtained from the access system 114, so as to populate the passenger record database 122 in a manner which is most compatible with further operations of the passenger flow analyzer 102.

Additionally, or alternatively, the stream monitor 124 may be configured to monitor content of the passenger record database 122, and to provide associated passenger record data to a destination prediction generator 126 of the passenger flow analyzer 102. As described in detail below, the destination prediction generator 126 is configured to use historical passenger record data from the passenger record database 122 to construct one or more classification models characterizing a probability that an individual passenger entering an origin station of the transit system 104 will travel to one or more destination stations of the transit system 104, based on a number of conditions or access variables present at a time of ingress of the passenger to the transit system 104.

In this way, in response to a real-time ingress notification 116, 118, a passenger flow forecaster 128 may be configured to utilize one or more of the classification models of the destination prediction generator 126, in conjunction with the one or more ingress notifications 116, 118, in order to predict potential future travels of individual passengers who have entered the transit system 104 and who are currently in transit therein.

In other words, the destination prediction generator 126 is configured to utilize historical passenger record data characterizing individual trips of individual passengers that have already been completed, while the passenger flow forecaster 128 is configured to forecast one or more destination stations for individual passengers who have gained access to the transit system 104 and who are currently in transit therein.

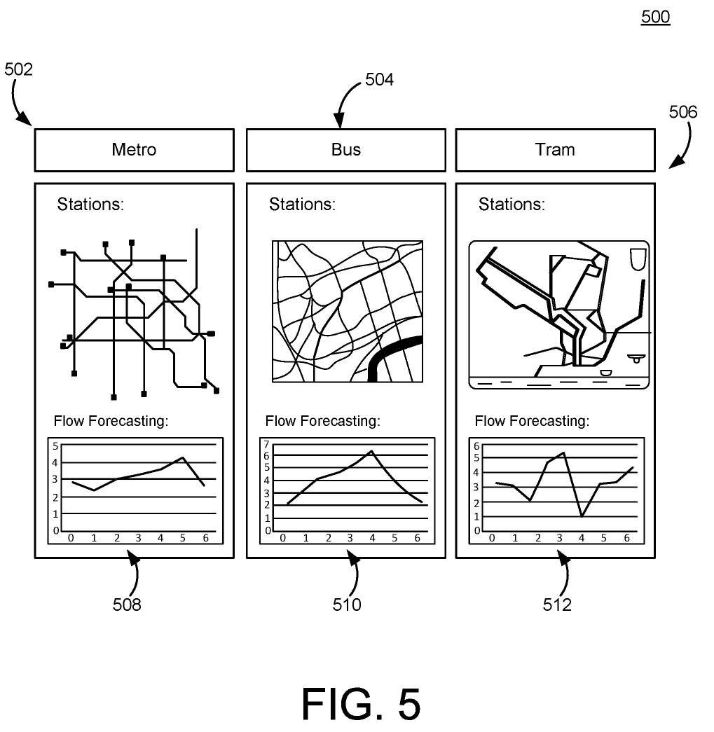

In this way, as referenced above, the view generator 130 may be configured to display, using the passenger flow UI 120, a current, dynamic, real-time passenger flow within the transit system 104, using aggregated passenger forecast determined from the individual passenger forecast calculated by the passenger flow forecaster 128. For example, as illustrated and described below with respect to FIG. 5, the view generator 130 may display a map of the transit system 104, or one or more individual destination stations thereof, along with information characterizing or illustrating a predicted number of passengers at each displayed destination station, within a corresponding, predicted time window. In this way, as described, an operator of the transit system 104 may be provided with information for scheduling transportation vehicles to arrive at the illustrated destination stations within the corresponding time windows, so as to ensure an arrival of an appropriate number of such transportation vehicles, thereby ensuring efficient operation of the transit system 104 and the convenient use thereof by current and future passengers.

In some implementations, it is not necessary to provide the type of visual display of the transit system 104 just referenced. For example, the predicted, aggregated passenger flows may be stored in an appropriate table or other storage format, and utilized to generate corresponding transit system schedules.

That is, as shown, a schedule generator 131 may be configured to leverage predictions of the passenger flow forecaster 128. For example, in the various implementations just referenced, the passenger flow UI 120 may be utilized by an operator of the passenger flow analyzer 102 to input or select corresponding scheduling information, which may then be utilized by an operator of the transit system 104 to schedule operations at corresponding destination stations. In other implementations, the scheduled generator 131 may be configured to automatically generate schedules and schedule corresponding arrivals of transportation vehicles at corresponding destination stations of the transit system 104.

In the example of FIG. 1, the passenger flow analyzer 102 is illustrated as executed using at least one computing device 132. As shown, the at least one computing device 132 may include at least one processor 134, as well as non-transitory computer readable storage medium 136. Of course, the at least one computing device 132 may be associated with various other hardware and software features not explicitly illustrated in the simplified example of FIG. 1. For example, the at least one computing device 132 will typically have a monitor, display, or screen for providing the passenger flow UI 120, as well as any number of desired, associated peripheral or input/output devices.

As may be appreciated, the at least one computing device 132 may represent two or more computing devices in communication with one another. For example, although the passenger flow analyzer 102 is illustrated as a single, discrete module including the various sub-modules 122 and 124-131, the passenger flow analyzer 102 may be implemented with various ones of the sub-modules 122-131 executing on two or more computing devices. For example, as referenced above, at least a portion of the passenger flow analyzer 102 may be implemented in conjunction with the access system 114 and the context of the transit system 104, while other portions of the passenger flow analyzer 102 may be implemented separately, by a third-party provider.

Similarly, the at least one processor 134 may represent two or more processors executing in parallel. For example, the one or more such processors may operate to execute instructions stored on the non-transitory computer readable storage medium 136, so as to execute and implement the passenger flow analyzer 102. For example, different ones of the components 124-131 may be executed in parallel. Moreover, although the various components 122-131 are illustrated as a single, discrete components, any one of the components 122-131 may be executed as two or more subcomponents. Similarly, but conversely, any two of the illustrated components may be executed together as a single component.

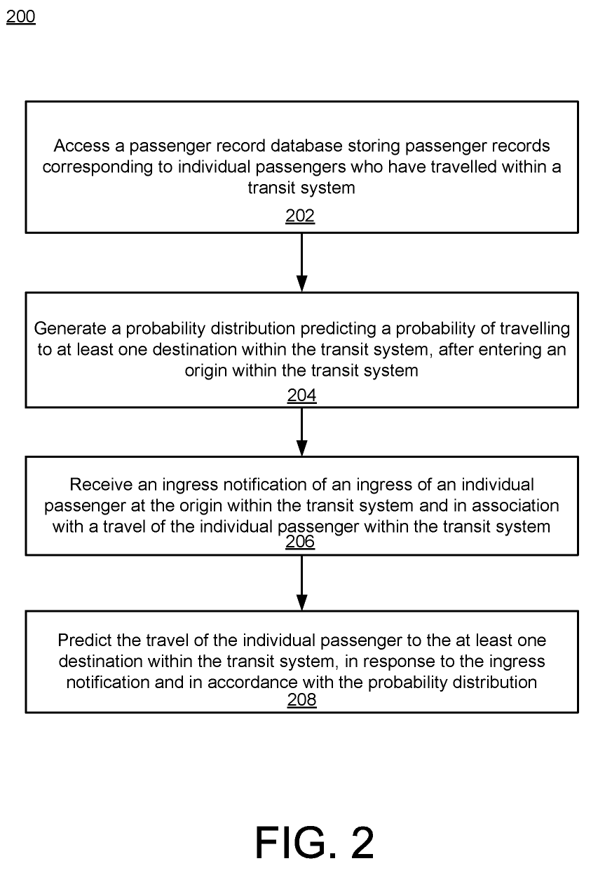

FIG. 2 is a flowchart 200 illustrating example operations of the system 100 of FIG. 1. In the example of FIG. 2, operations 202-208 are illustrated as separate, sequential operations. However, in various implementations, various additional or alternative operations may be included, and may be executed, e.g., in a branched, nested, iterative, looped, and/or overlapping/parallel manner.

In the example of FIG. 2, a passenger record database storing passenger records corresponding to individual passengers who have traveled within a transit system may be accessed (202). For example, the destination prediction generator 126 may be configured the passenger record database 122 of FIG. 1. As described with respect to the example of FIG. 1, the accessed passenger records reflect historical data characterizing individual trips taken by passengers within the transit system 104.

A probability distribution predicting a probability of traveling to at least one destination within the transit system, after entering an origin within the transit system, may be generated (204). For example, the destination prediction generator 126 may utilize the passenger records to generate and train a classification model characterizing a probability that an individual passenger entering an origin station, such as the origin station 106 or the origin station 108, will travel to a destination station, such as the destination station 110 and/or the destination station 112.

In other words, as described in more detail below, the passenger record database 122 may reflect historical data demonstrating that a plurality of passengers entering the transit system 104 at the origin station 106 travel to the destination station 110. Such travel will be associated with corresponding travel conditions or attributes for each trip and each individual. For example, such conditions might include the time of day of the trip, a time of the month or year of the trip, and whether the passenger utilized a personal/unique identifier for accessing the transit system 104 (as opposed to passengers who use generic, one-time access cards or other techniques for accessing the transit system 104). Then, by utilizing the historical passenger records, associated origin/destination information, and associated travel conditions for each trip, the destination prediction generator 126 may train a classification model for future, real-time or near real-time predictions of current passenger flow within the transit system 104.

An ingress notification of an ingress of an individual passenger at the origin within the transit system and in association with the travel of the individual passenger within the transit system may be received (206). For example, the stream monitor 124 may receive some or all of the ingress notification 116, via the access system 114, and may forward the received ingress notification 116 to the passenger flow forecaster 128. Alternatively, the passenger flow forecaster 128 may access the ingress notification from the passenger record database 122, perhaps in response to a notification from the stream monitor 124 that the ingress notification 116 has been received and stored.

The travel of the individual passenger to the at least one destination within the transit system may be predicted, in response to the ingress notification and in accordance with the probability distribution (208). For example, the newly-received ingress notification 116, reflecting an entrance of an individual passenger at the origin station 106, may be analyzed for its associated travel attributes or conditions. Then, the passenger flow forecaster 128 may utilize these travel conditions as the attributes for the classification model generated and trained by the destination prediction generator 126. As a result, the passenger flow forecaster 128 provides a probability distribution predicting relative likelihoods that the individual passenger who has entered at the origin station 106 will travel to the destination station 110 and/or the destination 112, or other destination stations of the transit system 104.

For example, the passenger flow forecaster 128 may thus determine that the individual passenger corresponding to the ingress notification 116 and entering the transit system 104 at the origin station 106, has a 70% chance of traveling to the destination station 110 (as opposed to some other destination station, not shown in FIG. 1), as well an additional 30% chance of traveling onward to the destination station 112. Meanwhile, the passenger flow forecaster 128, using the same or similar techniques just described, may predict that an individual passenger corresponding to the ingress notification 118 and entering the transit system 104 at the origin station 108, has a 50% chance of traveling to the destination 110, and a 50% chance of traveling directly to the destination station 112.

Thus, the passenger flow forecaster 128 may be configured to calculate the aggregated odds that a particular destination, such as the destination station 110, will experience a given influx of passengers at a given point in time. In some examples, the view generator 130 may be configured to visually display the aggregated probability distributions for various individual passengers who are currently traveling within the transit system 104, in a manner which reflects the calculated relative odds that a given passenger will travel to one or more of the predicted destination stations.

In this way, for example, the user of the passenger flow UI 120 may opt to view the forecasted passenger flow for a selected one of its destination stations 110, 112, e.g., the destination station 110. Additionally, the user of the passenger flow UI 120 may elect to view forecasted passenger flows for all destination stations within a transit system 104, or any identified subset thereof. Again, the display, forecasted passenger flows will be reflective of dynamic, real-time, or near real-time movements of individual passengers within the transit system 104. Consequently, the displayed passenger flows may be updated, e.g., either to reflect new passengers entering the system, or to reflect currently-traveling passengers exiting the transit system 104. Similarly, the forecasted passenger flows may be updated to reflect the current travel status of the individual passenger in question.

It will be appreciated that the system of FIG. 1 and associated methods of FIG. 2 provide accurate and detailed forecasting for passenger flow within the transit system 104, which, in turn, is very useful for the optimization of a service level of the transit system 104. For example, in addition to optimization of a number of transportation vehicles at a given destination station within a given time window, other optimizations, such as a determination of a total number of transportation vehicles that should be deployed within the transit system 104 with any given time period (e.g., a day), and other optimization aspects, may be provided.

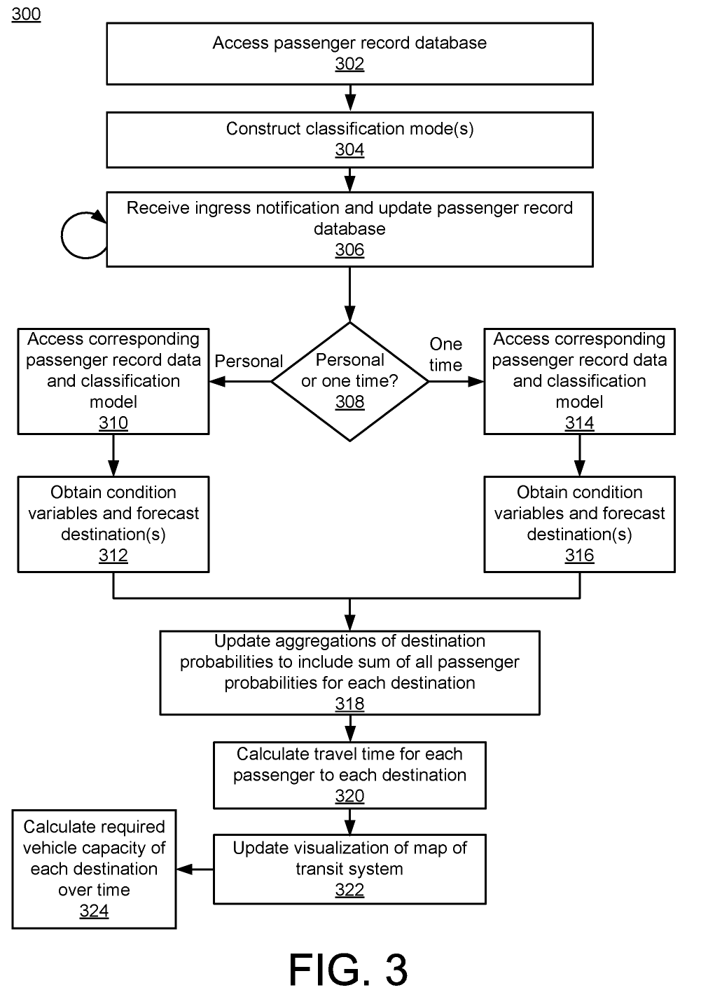

In the following examples of FIGS. 3-5, scenarios are described in which the transit system 104 represents a public transportation system of a city, such as a subway system. In the examples, traceable identification used to provide the individual ingress notifications 116, 118, as well as egress notifications 117, 119, may be provided using the type of smart traffic card referenced above as an example implementation of the access system 114. As referenced, the use of the smart traffic card represents a widely used technique for ticketing throughout the world, in which passengers swipe their smart traffic card upon entrance and exit of the transit system 104. As described, the access system 114 may thus automatically charge the access fee, and write a travel record to the passenger record database 122, or an intermediate database, in real-time or near real-time.

For example, it may occur that an individual passenger enters the transit system 104, e.g., a subway system of the city, at the origin station 106. The ingress notification 116 is thus transmitted to the access system 114, e.g., in response to a swiping of an access card by the individual passenger upon entry to the origin station 106. If the passenger travels to the destination station 110 and then exits the transit system 104, a subsequent, corresponding swipe of the access card at the destination station 110 will thus be reported as egress notification 117 to the access system 114. Meanwhile, an individual passenger entering the transit system 104 at the origin station 108, resulting in transmission of the ingress notification 118 to the access system 114, might travel to the destination station 110, and then to the destination station 112. Upon exiting the transit system 104 at the destination station 112, the egress notification 119 may be transmitted from the destination station 112 to the access system 114. On the other hand, it might also occur that the individual passenger entering the origin station 108 travels directly to the destination station 112, so that the same egress notification 119 might be transmitted upon exit of the individual passenger from the destination station 112, but after a shorter trip within the transit system 104.

Thus, in general, it will be appreciated that the various individual passengers may enter the transit system 104 at one or more of the various stations of the transit system 104, each of which thus serves as an origin station for purposes of the entrance of the corresponding individual passenger. However, at that point in time, the individual passenger typically is provided with access to many potential destination stations of the transit system 104, and there may be no immediate way to determine, just based on the ingress notification 118 and the associated characteristics, which destination station will ultimately be selected by the individual passenger in question. For example, some transit systems might provide unlimited access to, and use of, transportation vehicles, as long as the individual passenger is within the transit system 104, so that the individual passenger could theoretically select any desired destination station.

Thus, in the following example implementations of FIGS. 3-5, the system of FIG. 1 and methods of FIG. 2 for a passenger flow forecasting based on traceable identification data is provided. As also described, both historical data and streaming data from the smart traffic card system represented by the access system 114 of FIG. 1 are used to predict passenger flow at any time during operational hours of the transit system 104, as well as at virtually any location (e.g., station) within the transit system 104. As described, for each inbound passenger, the inbound time, the origin station information, and any associated information, may be used to forecast a destination station of the passenger in question, e.g., as a probability distribution. The individual passenger may then be added to an aggregated passenger flow representing other passengers within the transit system 104, and, e.g., may be displayed in conjunction with a map of the transit system 104 and/or may be stored within an appropriate database table.

Advantageously, as described, the techniques described herein utilize real-time or near real-time data with respect to individual passengers. Both prepaid and pay-as-you-go traffic cards are supported. For example, both traffic cards that are specific to a unique individual, as well as traffic cards that are generic and designed for one-time use, may be utilized in the passenger flow forecasting described herein. Further, the ability for fine-grained forecasting, including both temporal and geographical forecasting, is provided.

Since both historical and real-time data are utilized, the resulting passenger flow forecasting is highly accurate, detailed, and current. Moreover, it is not necessary to review all the calculations when providing updated passenger flow forecasting. Instead, for example, the real-time ingress notifications received may simply be provided to, or used in conjunction with, the classification model of the destination prediction generator 126, and the classification model may routinely be retrained to reflect most recent historical passenger records.

Thus, in the example of FIG. 3, in the flowchart 300, the passenger record database 122 is accessed (302) by the destination prediction generator 126, and the resulting historical passenger records are used to construct a classification model or models (304). Once the classification model has been constructed and/or updated, ingress notifications may be received as individual passengers enter the transit system at various corresponding origin stations, and the passenger record database 122 may correspondingly be updated (306).

As referenced above, for a given ingress notification, the corresponding smart traffic card may be a personal, unique smart traffic card, or a generic, one-time use traffic card (308). If the smart traffic card is a personal, unique card, then a corresponding quantity of passenger record data and associated classification model may be accessed (310). In other words, for a single, identified, unique individual passenger, the destination prediction generator 126 may construct and train a classification model that is applicable for that individual passenger. For example, individual passengers may have relatively predictable routines, e.g., with respect to travel to and from work on the weekdays, or travel to preferred vacation destinations on the weekends or holidays. Consequently, the corresponding classification model may provide highly personalized, specialized destination predictions for the identified individual passenger.

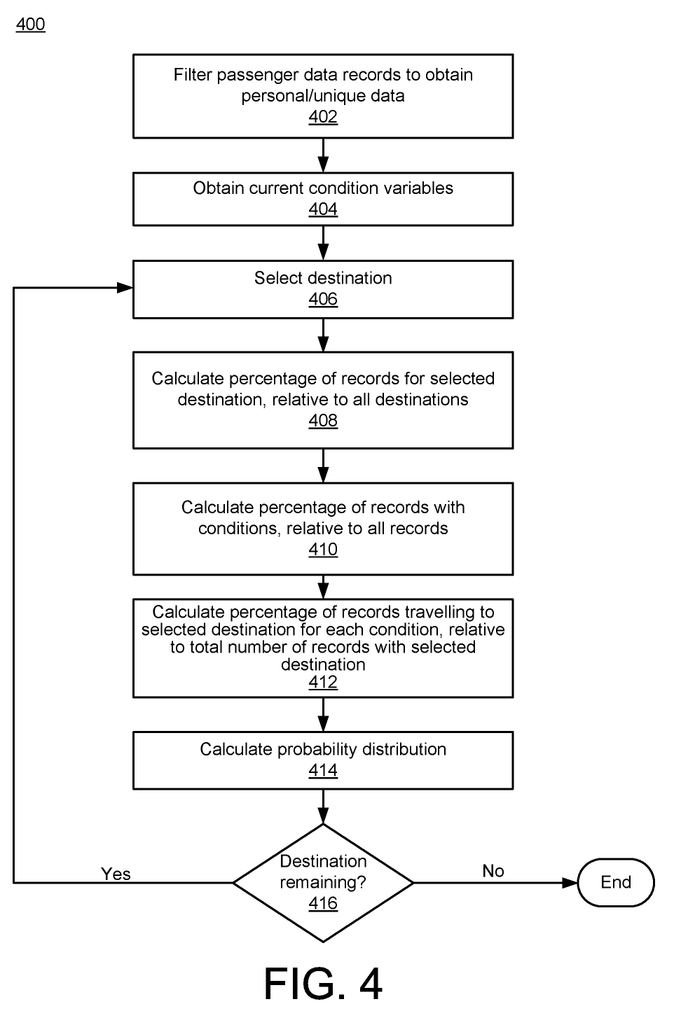

From the passenger record associated with the current ingress notification, various associated condition variables may be obtained, such as a time of entry, and one or more destinations may be forecast for the individual passenger in question (312). Further details regarding calculation techniques in the context of a personal, unique smart traffic card are provided below with respect to FIG. 4.

Meanwhile, if the ingress notification is determined to be associated with a generic or one-time use smart traffic card (308), then a corresponding quantity of passenger record data and associated classification model may be accessed (314). For example, as referenced below with respect to FIG. 4, the classification model of the destination prediction generator 126 may be constructed with respect to passenger record data associated with users of such generic or one-time access cards. In some cases, a subset of such passenger record data may be used to construct the classification model to be used. For example, the classification model in such cases might be constructed with respect to passenger record data for passengers using such generic or one-time smart traffic cards at the same origin station associated with the current ingress notification.

Using the determined classification model and associated parameters, for example, an identification of the origin station in question, a time of access thereto, and other information from the received passenger record may be provided to the selected classification model, to thereby enable the passenger flow forecaster 128 in forecasting one or more destinations for the individual passenger in question (316).

In this way, a probability distribution forecasting relative likelihoods that a given individual passenger will travel to one or more destination stations may be provided. The resulting plurality of calculated probability distributions may thus be aggregated as a sum of all passenger probabilities for each destination (318). For example, once the calculated probability distribution of destinations for each inbound passenger is known, a corresponding travel time may be estimated for each origin/destination station pair. The aggregated passenger flow forecasting can be calculated based on the various destination probabilities of all the passengers.

For example, with the simplified example of FIG. 1, it might occur that an individual passenger at the origin station 106 has a probability of 0.2 of traveling to the destination station 110, and 0.8 of traveling to the destination station 112. Meanwhile, the individual passenger at the origin station 108 might have a probability of 0.3 of traveling to the destination station 110, and 0.7 of traveling to the destination station 112.

As referenced above, the flow strength or passenger flow strength may be calculated as a sum of probabilities of all passengers traveling to a particular destination. Thus, in the simplified example, the flow strength for the destination station 110 is 0.2+0.3=0.5. Meanwhile, the flow strength for the destination station 112 may be calculated as 0.8+0.7=1.5.

In this way, travel time for each passenger to each destination may be calculated (320). In other words, by using the various destination stations, the time needed for each passenger to travel to each destination station may be calculated. For example, traveling to the destination station 110 may require 10 minutes from each of the origin stations 106, 108, while traveling to the destination station 112 (e.g., by way of the destination station 110) may require 30 minutes. Thus, the passenger flow strength of the 0.5 will last about 10 minutes, while the passenger flow strength of the 1.5 will last about 30 minutes. As referenced above with respect to the passenger flow UI 120, and illustrated in more detail below with respect to FIG. 5, because public transportation routes are typically predefined, the aggregated passenger flow may be visualized at the passenger flow UI 120.

For example, if a user of the passenger flow UI 120 wishes to see a visualization of the passenger flow after 5 minutes, both of the two example passenger flows will be displayed on the visualization of the passenger flow UI 120. On the other hand, if the user of the passenger flow UI 120 visualizes the passenger flow after 20 minutes, the flow with strength 0.5 will have disappeared, while the flow with strength 1.5 will still exist. If the end user wants to know the passenger flow after 40 minutes, both of the two passenger flows will have disappeared. Thus, using these and related techniques, the visualization of the map of the transit system with the associated aggregated passenger flows may be updated (322). Of course, additional or alternative techniques may be used. For example, in the examples just referenced, the passenger flows are timed out based on the calculated travel times. In some cases, however, a passenger flow may be terminated upon receipt of a corresponding egress notification. For example, if the individual passenger entering at the origin station 106 is predicted to travel to each of the destination stations 110, 112 with a certain probability distribution, as referenced above, it may occur that the egress notification 117 notifies the access system 114 that the individual passenger has exited the transit system at the destination station 110. In such scenarios, the aggregated passenger flow would reflect the deletion of the projected possibility of the passengers traveled to the destination 112.

At any point in time that the aggregated passenger flow is predicted, required vehicle capacity at each destination and associated time window may be calculated (324). For example, a user of the passenger flow analyzer 102 may configure the passenger flow analyzer 102 to display any desired time and station for which the user wishes to predict passenger flow. For example, the passenger flow analyzer 102 may be utilized to forecast an inbound/outbound passenger flow for the station 110 at a given time. In another example, an inbound/outbound passenger flow for an entire metro line (e.g., for stations 106, 110, 112 may be predicted). In yet another example, inbound/outbound passenger flow for all stations (e.g., 106-112) may be predicted for a given time window. In a final example, an inbound/outbound passenger flow for the destination station 110 may be predicted for a time interval, at defined sub-intervals. That is, within the indicated time range, the passenger flow analyzer 102 will generate multiple passenger flow forecasts, where the number of forecasts depends on the defined number of intervals.

FIG. 4 is a flowchart illustrating example operations of the system of FIG. 1, when using a personal smart travel card. As described, the system 100 of FIG. 1 permits prediction of the passenger's destination, based on the passenger's own travel data.

In FIG. 4, first the passenger data records are filtered to obtain data from the passenger in question (402). Current condition variables, referred to as variables “x”, are obtained (404), and may include, e.g., a current time, current day of the week, current station, current day of the month, current month or current year.

Then a destination of possible destinations is selected (406). A percentage of records for the selected destination, relative to all destinations for the personal access card, may be calculated (408), referred to as a matter of notation below as percentage p(Cₖ) for a destination Cₖ. A percentage of records matching the current conditions may be calculated, relative to all travel records for the personal access card (410), referred to as a matter of notation below as percentage p(x) for conditions x. Also, a percentage of records travelling to the selected destination for each condition may be calculated, relative to the total number of passenger records for the passenger card having the selected destination (412).

Then, the probability distribution may be calculated (414). For example, as referenced above, the naive Bayesian model may be used to provide a probability distribution and associated classification technique. For example, in general for a vector of dependent variables x=(v₁, v₂, v₃, v₄, . . . , v₁), the model calculates the probability that this vector belongs to a given class using Equation (1):

$$p ( {C}_{k} \text{\textbar} x ) = \frac{p ( {C}_{k} ) ⋆ p ( x \text{\textbar} {C}_{k} )}{p ( x )} \qquad Equation ( 1 )$$

In Equation (1), Cₖ represents a class with label K and p(Cₖ|x) is the probability that x implies Cₖ. As already described, the vector x represents dependent variables such as current time, in-bound station, and card type, and the classes are the group of potential destination stations.

Thus, in the example of FIG. 4, training of the Naïve Bayesian model is based on the historical passenger data, so that the values p(Cₖ), p(x|Cₖ) and p(x) can be determined from the passenger records. For example, using this notation, operation 408 can be executed using Equation (2):

$$p ( {C}_{k} ) = \frac{num ( {C}_{k} )}{num ( C )} \qquad Equation ( 2 )$$

As referenced above, num(Cₖ) is the number of passenger records for the passenger for which the destination is the selected destination Cₖ. Meanwhile, num(C) represents the total number of passenger records of the personal access card.

Further, p(x) represents the total number of passenger records with the condition x, and num(x|Cₖ) represents a number of passenger record for travel to the selected destination Cₖ when the condition is x. So, with respect to the example of operation 412, Equation (3) demonstrates the percentage of passenger records travelling to the selected destination for each condition x, relative to the total number of passenger records for the selected destination:

$$p ( x \text{\textbar} {C}_{k} ) = \frac{num ( x \text{\textbar} {C}_{k} )}{num ( {C}_{k} )} \qquad Equation ( 3 )$$

Accordingly, all values can be calculated for utilizing Equation (1) to determine the probability distribution (414). The process may continue until no destinations are remaining to be selected (416), at which point the process ends. As will be appreciated from the above description, the result is a trained classification model that can be used to predict individual passenger travel with a high degree of accuracy. It will also be appreciated that the techniques of FIG. 4 may be used to continually or frequently update the classification model, so as to maintain or improve the accuracy of the model.

Other techniques may be used to calculate the probability distribution. For example, various types of regression may be used, and/or a neural network model or support vector machine (SVM).

As referenced, FIG. 4 has been described above with respect to the example in which a personal access card is used. However, techniques can also be used for one-time or single-use cards. In such cases, the same basic process flow and technique of FIG. 4 may be used. However, instead of using the passenger records for the individual passenger, a subset of passenger records may be used.

For example, with reference to operation 402, filtering of the passenger records may proceed such that the filtered subset of passenger records may be selected as a subset of other passenger records for which one-time or single-use cards were used. Additionally, or alternatively, passenger records may be selected based on the origin station, or on the time of day or other condition. Then, the subsequent operations may proceed as described above, but with percentages calculated relative to the filtered subset of passenger records, instead of relative to the unique card of a passenger.

FIG. 5 is a screenshot of example user interfaces that may be used in the system of FIG. 1. FIG. 5 illustrates first user interface 502 for a metro transit system, in which flow forecasting 508 is provided. FIG. 5 illustrates a second user interface 504 for a bus transit system, in which flow forecasting 510 is provided. FIG. 5 also illustrates a third user interface 506 for a tram transit system, in which flow forecasting 512 is provided.

Although the user interfaces 502-506 of FIG. 5 are highly simplified, they provide a conceptual illustration that a user may easily select, e.g., a particular station, metro line, or entire transit system, and view a corresponding flow forecasting. For example, as referenced above, it is possible to show how many passengers will be expected at a given station over and during a period of time, where the displayed flow represents actual passengers currently travelling within the metro system.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed, are configured to cause at least one computing device to:
access a passenger record database storing passenger records corresponding to individual passengers who have travelled within a transit system;
generate a probability distribution predicting a probability of travelling to at least one destination within the transit system, after entering an origin within the transit system;
receive an ingress notification of an ingress of an individual passenger at the origin within the transit system and in association with a travel of the individual passenger within the transit system; and
predict the travel of the individual passenger to the at least one destination within the transit system, in response to the ingress notification and in accordance with the probability distribution.

2. The computer program product of claim 1, wherein the instructions, when executed by the at least one computing device, are further configured to:
generate the probability distribution including training, using the passenger record database, a classification model in which the at least one destination is included as a class, and in which ingress notification attributes are applicable to the classification model to obtain the at least one destination.

3. The computer program product of claim 1, wherein the ingress notification is obtained in conjunction with an access event by the individual passenger in which payment is received from the individual passenger in exchange for corresponding access to the transit system.

4. The computer program product of claim 3, wherein the access event is personalized to a unique identifier for the individual passenger.

5. The computer program product of claim 4, wherein the instructions, when executed by the at least one computing device, are further configured to:
access unique passenger records corresponding to the individual passenger from the passenger record database;
generate the probability distribution based on the unique passenger records; and
predict the travel based on the unique passenger records.

6. The computer program product of claim 1, wherein the access event is a one-time access event that is generic with respect to the individual passenger.

7. The computer program product of claim 6, wherein the instructions, when executed by the at least one computing device, are further configured to:
access passenger records corresponding to the one-time access event from the passenger record database;
generate the probability distribution based on the corresponding passenger records; and
predict the travel based on the corresponding passenger records.

8. The computer program product of claim 1, wherein the instructions, when executed by the at least one computing device, are further configured to predict the travel of the individual passenger while the individual passenger is in transit from the origin and before the individual passenger has reached the at least one destination.

9. The computer program product of claim 1, wherein the instructions, when executed by the at least one computing device, are further configured to:
predict a second travel of a second individual passenger to the at least one destination, based on a second ingress notification of the second individual passenger;
calculate a combined passenger flow to the at least one destination, reflecting a combined probability distribution for the first individual passenger and the second individual passenger.

10. The computer program product of claim 1, wherein the at least one destination includes at least two destinations, each with a probability of the probability distribution, and further wherein the instructions, when executed by the at least one computing device, are further configured to:
display, in conjunction with a map of the transit system, the predicted travel of the individual passenger to each of the at least two destinations, including a time of each travel.

11. The computer program product of claim 1, wherein the instructions, when executed by the at least one computing device, are further configured to:
predict, for a destination of the at least one destination, a number of passengers, including the individual passenger, who will transit the destination within a time window; and
calculate a corresponding capacity of transportation vehicles of the transit system to be used to meet transportation demands of the number of passengers.

12. A computer-implemented method for executing instructions stored on a non-transitory computer readable storage medium, the method comprising:
generating a first probability distribution predicting, for a first passenger at a first origin of a plurality of origins of a transit system, a probability of travelling therefrom to at least a first destination within the transit system;
generating a second probability distribution predicting, for a second passenger at a second origin of the plurality of origins of the transit system, a probability of travelling therefrom to at least the first destination within the transit system;
receiving a first ingress notification of a first individual passenger at the first origin;
receiving a second ingress notification a second individual passenger at the second origin; and
predicting a combined probability of travel of the first individual passenger and the second individual passenger to the first destination, based on the first probability distribution, the second probability distribution, the first ingress notification, and the second ingress notification.

13. The method of claim 12, wherein the generating the first probability distribution and the generating the second probability distribution include:
determining first notification attributes of the first ingress notification;
applying the first notification attributes to a classification model to generate the first probability distribution, wherein the first destination is included as a class within the classification model, the classification model having been trained using a passenger record database storing passenger records corresponding to individual passengers who have travelled within the transit system;
determining second notification attributes of the second ingress notification; and
applying the second notification attributes to the classification model to generate the second probability distribution.

14. The method of claim 12, wherein the predicting the combined probability of travel occurs after receipt of the first ingress notification and the second ingress notification, and before arrival of either the first individual passenger or the second individual passenger at the first destination.

15. The method of claim 12, further comprising:
displaying, in conjunction with a map of the transit system, the combined probability of travel of the first individual passenger and the second individual passenger to the first destination.

16. A system including instructions recorded on a non-transitory computer-readable storage medium, and executable by at least one processor, the system comprising:
a destination prediction generator configured to access a passenger record database of travel records for individual passengers and generate therefrom a classification model characterizing a probability that an individual passenger entering an origin station of a transit system will travel to a destination station of a plurality of destination stations;
a passenger flow forecaster configured to receive an ingress notification for an individual passenger at the origin station, and further configured to forecast, based on attributes of the ingress notification as applied to the classification model, at least one predicted destination station of the plurality of destination stations; and
a view generator configured to output, for the at least one predicted destination station, a predicted passenger flow for the at least one predicted destination that includes the individual passenger.

17. The system of claim 16, further comprising a stream monitor configured to receive the ingress notification in conjunction with an access event by the individual passenger in which payment is received from the individual passenger in exchange for corresponding access to the transit system, and further configured to forward the ingress notification to the passenger flow forecaster.

18. The system of claim 17, wherein the access event is personalized to a unique identifier for the individual passenger, and the destination prediction generator is configured to train the classification model based on passenger records of the passenger record database corresponding to the individual passenger.

19. The system of claim 16, wherein the passenger record database is updated based on the ingress notification, and wherein the destination prediction generator is further configured to re-train the classification model, based on the updated passenger record database.

20. The system of claim 16, wherein the view generator is further configured to display, in conjunction with a map of the transit system, the predicted passenger flow as reflecting predicted passengers transiting the at least one predicted destination station within a defined time window.
